(19) United States
(12) Patent Application Publication
(10) Pub. No.: US 2004/0105674 A1
(43) Pub. Date: Jun. 3, 2004

(54) Method making use of several times of flashes to detect distance and luminance of target

(75) Inventor: Sam Yeh, Hsinchu (TW)

Correspondence Address: BROWDY AND NEIMARK, P.L.L.C., 624 NINTH STREET, NW, SUITE 300, WASHINGTON, DC, 20001-5303, US

(73) Assignee: Premier Image Technology Corporation, Taipei (TW)

(21) Appl. No.: 10/307,345

(22) Filed: Dec. 2, 2002

(51) Int. Cl. G03B 15/03

(52) U.S. Cl. 396/155

(57) ABSTRACT

A method making use of several times of flashes to detect the distance and luminance of a target is proposed. The method applies to an image capturing device. First, a flashlight installed in the image capturing device emits out a flash to illuminate the target. A flash response value reflected by the target is then received. Next, a distance value and a luminance value corresponding to the target are calculated according to the flash response value. Subsequently, whether the flashlight emits out a flash of an appropriate intensity is determined according to the distance value and the luminance value. If the flashlight does not emit out a flash of an appropriate intensity, the step of emitting out a flash to illuminate the target by the flashlight of the image capturing device is repeated.

### FIELD OF THE INVENTION

The present invention relates to a method of detecting the distance and luminance of a target for an image capturing device and, more particularly, to a method making use of several times of flashes to detect the distance and luminance of a target for an image capturing device.

### BACKGROUND OF THE INVENTION

In order to obtain a clear and satisfactory photograph when using a camera to take a picture of a target (a scenery, a figure or an article), it is necessary to properly adjust the focal length and luminance of the target.

Along with continual progress of science and technology, cameras evolve from manual focusing to automatic focusing, from manual switching of flash to automatic switching of flash, and from conventional type with negatives installed therein to digital type with digital image data stored therein, hence greatly enhancing the convenience of using cameras. Moreover, the taken pictures can be stored in digital way, can be modified using computers, and can be stored for a much longer time.

FIG. 1 shows a partial circuit block diagram of a conventional digital camera. A micro-computer 102 controls a charge-coupled device (CCD) imager 104 to detect the reflected light intensity from a target. The CCD imager 104 sends out the detected light intensity using a charge signal, which is sent into the micro-computer 102 after conversion from analog form into digital form, storage, and digital data calculation. Digital data of a complete picture can be obtained after image processing by the micro-computer 102.

In FIG. 1, the micro-computer 102 can also control a flashlight 106. When the micro-computer 102 issues a flash instruction, the flashlight 106 will emit out a flash. The flashlight 106 can be manually set to emit out a flash, and can also emit out a flash by automatic detection when taking a picture. If the digital camera is to have automatic flashing function, it is necessary to add a photo sensor (not shown) in FIG. 1.

FIG. 2 shows an operation flowchart of a conventional digital camera having automatic flashing function. In FIG. 2, when a digital camera is used to take a picture of a target, a photographing key is first pressed down (S202). The photo sensor will detect the reflected light intensity from the target (S204), and sends out a detection signal corresponding to this light intensity to the micro-computer 102 (referring to FIG. 1). When the reflected light intensity from the target detected by the photo sensor is too weak, the micro-computer 102 will issue a flash instruction to the flashlight 106 to let the flashlight emit out a flash. The micro-computer 102 has an inbuilt flashlight match program. When the micro-computer 102 executes the flashlight match program, it will receive the detection signal sent out from the photo sensor. The flashlight match program can control the emitted flash intensity of the flashlight to the target according to the detection signal.

However, the cost will increase for a digital camera using the photo sensor to determine the flash intensity to the target. Moreover, when a camera takes a picture of a target at a short distance, if the flashlight is required to emit out a flash, over exposure of the picture will arise due to a too strong luminance of the flash.

### SUMMARY OF THE INVENTION

Accordingly, the present invention provides a method making use of several times of flashes to detect the distance and luminance of a target. The method utilizes the architecture of an original image capturing device and its flashlight match program to give appropriate luminance to targets at different distances and accomplish short-distance flash for avoiding over exposure of pictures.

The present invention provides a method making use of several times of flashes to detect the distance and luminance of a target. The method applies to an image capturing device. In the method, a flashlight installed in the image capturing device first emits out a flash to illuminate a target. A flash response value reflected by the target is then received. Next, a distance value and a luminance value corresponding to the target are calculated according to the flash response value. Subsequently, whether the flashlight emits out a flash of an appropriate intensity is determined according to the distance value and the luminance value. If the flashlight does not emit out a flash of an appropriate intensity, the step of emitting out a flash to illuminate the target by the flashlight of the image capturing device is repeated. Thereby, the function of the flashlight can be enhanced, components can be saved, and the effects of distance detection and luminance detection can be accomplished by means of several times of flashes.

The various objects and advantages of the present invention will be more readily understood from the following detailed description when read in conjunction with the appended drawing, in which:

### BRIEF DESCRIPTION OF THE DRAWINGS

FIG. 1 is a partial circuit block diagram of a conventional digital camera;

FIG. 2 is an operation flowchart of a conventional digital camera having automatic flashing function; and

FIG. 3 is a flowchart of a method making use of several times of flashes of an image capturing device to detect the distance and luminance of a target.

### DETAILED DESCRIPTION OF THE PREFERRED EMBODIMENTS

The present invention provides a method making use of several times of flashes to detect the distance and luminance of a target. The method utilizes the architecture of an original image capturing device like a camera and a flashlight match program thereof to give appropriate luminance to targets at different distances and accomplish short-distance flash for avoiding over exposure of picture.

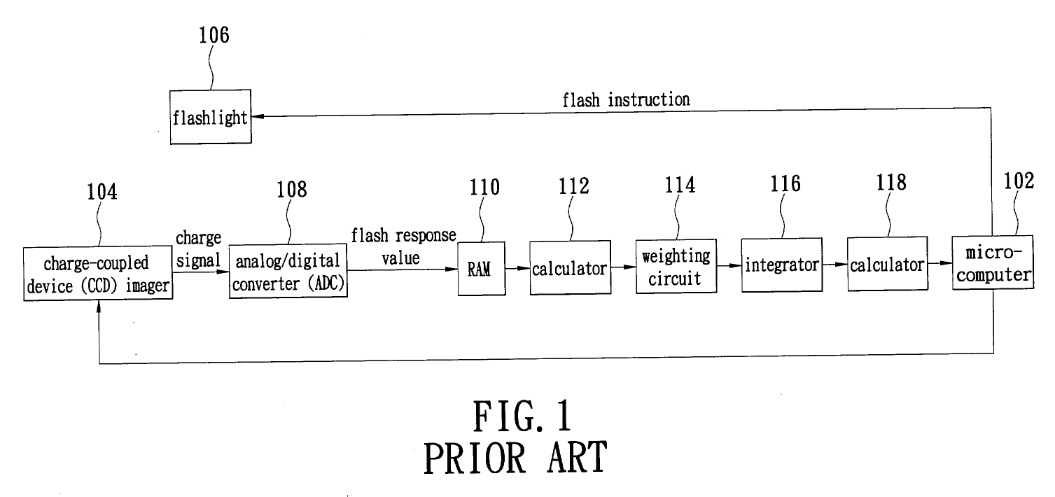

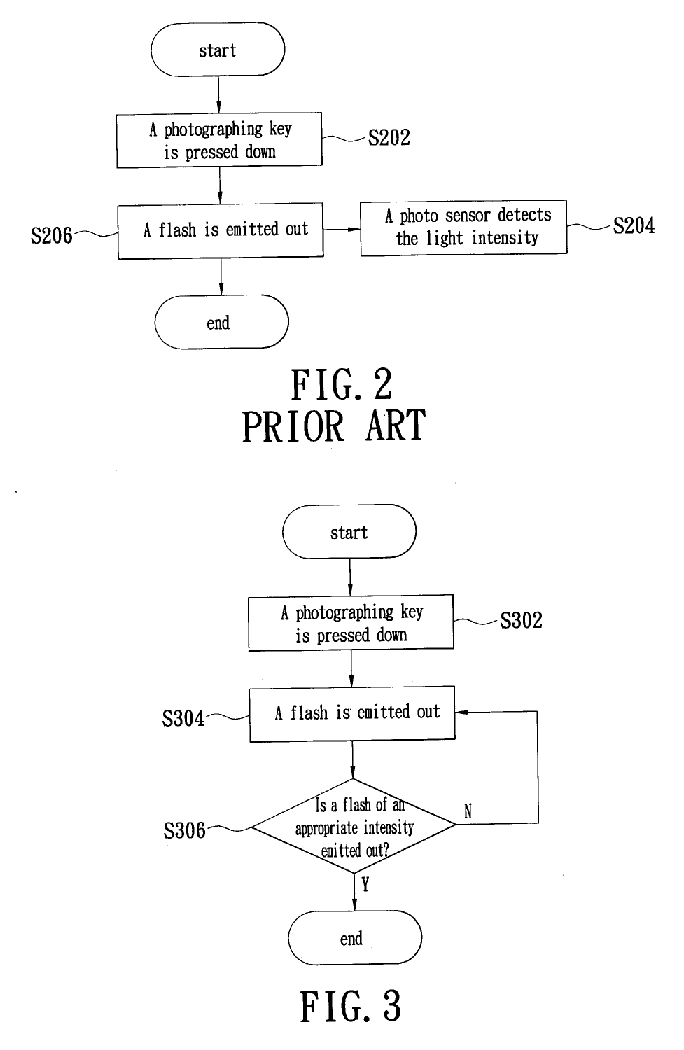

In the present invention, the above image capturing device is exemplified with a digital camera. The architecture of a digital camera shown in FIG. 1 and a flashlight match program of the digital camera are exploited to give appropriate luminance to targets at different distances and accomplish short-distance flash for avoiding over exposure of picture. FIG. 3 is a flowchart of a method making use of several times of flashes of an image capturing device to detect the distance and luminance of a target.

The description of FIG. 3 below will also refer to FIG. 1. When a photographing key of the digital camera is pressed down (S302), a micro-computer 102 will issue a flash instruction to a flashlight 106. The flashlight 106 will then emit out a flash to the target (S204). Next, the micro-computer 102 will control a CCD imager 104 to receive the reflected light intensity from the target. The CCD imager 104 will send a charge signal representing this light intensity to an analog/digital converter (ADC) 108, which will convert the analog form charge signal into a digital form flash response value. This flash response value is then sent into a RAM 110 for storage. After the flash response value stored in the RAM 110 is calculated by a calculator 112, a weighting circuit 114, an integrator 116 and a calculator 118, a distance value between the digital camera and the target and a luminance value corresponding to the target are sent into the micro-computer 102. A flashlight match program in the micro-computer 102 will determine whether the flashlight 106 emits out a flash of appropriate luminance to the target according to the distance value and the luminance value (S306). If the flashlight 106 does not emit out a flash of appropriate luminance, Step 204 is jumped back to. The flashlight 106 will emit out a flash again, and the flashlight match program will control the light intensity of the flash emitted by the flashlight 106. As long as the flashlight 106 does not emit out a flash of appropriate luminance, Steps 304 and 306 will be repeated until the flashlight 106 emits out a flash of appropriate luminance.

Therefore, in the method making use of several times of flashes to detect the distance and luminance of a target, the flashlight match program can adjust the flashlight 106 to emit out a flash of the most appropriate intensity according to different distances of the target. The digital camera can thus take a picture of a target at a short distance of 10 cm without over exposure of pictures.

The method of the present invention applies to any type camera. The system architecture of the digital camera in FIG. 1 is just an embodiment of the present invention. The invention is not limited to the details thereof.

To sum up, the present invention can enhance the function of a flashlight and save components to lower the cost of a camera. The present invention can also adjust the flash intensity of a flashlight, and can take a picture of a target at a short distance. Moreover, the present invention can make use of several times of flashes to achieve the effects of distance detection and luminance detection for a target.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A method making use of several times of flashes to detect the distance and luminance of a target, said method applying to an image capturing device, said method comprising the steps of:
(a) emitting out a flash to illuminate said target by a flashlight of said image capturing device;
(b) calculating and determining whether said flashlight emits out a flash of an appropriate intensity according to a flash response value;
(c) jumping back to said step (a) if said flashlight does not emit out a flash of an appropriate intensity.

2. The method making use of several times of flashes to detect the distance and luminance of a target as claimed in claim 1, wherein a photographing key is pressed down before said flashlight emits out said flash.

3. The method making use of several times of flashes to detect the distance and luminance of a target as claimed in claim 1, wherein said flashlight gives an appropriate luminance to said target according to a distance value and a luminance value calculated from said flash response value in said step (c).

4. The method making use of several times of flashes to detect the distance and luminance of a target as claimed in claim 3, wherein a flashlight match program is used to control said flashlight to give said appropriate luminance to said target.
